(19) United States
(12) Patent Application Publication
(10) Pub. No.: US 2009/0019926 A1
(43) Pub. Date: Jan. 22, 2009

(54) Method for operating a fuel-injection system, in particular of an internal combustion engine

(76) Inventor: Andreas Sommerer, Kernen (DE)

Correspondence Address: KENYON & KENYON LLP, ONE BROADWAY, NEW YORK, NY, 10004, US

(21) Appl. No.: 12/218,115

(22) Filed: Jul. 11, 2008

(30) Foreign Application Priority Data
Jul. 12, 2007 (DE) 102007032509.8

(51) Int. Cl. G01M 15/09

(52) U.S. Cl. 73/114.43

(57) ABSTRACT

A method for operating a fuel-injection system, in particular of an internal combustion engine, in which fuel stored inside a pressure reservoir is injected by at least one fuel injector. At least one performance quantity of the fuel injector that is a function of the fuel pressure prevailing inside the pressure reservoir is evaluated in order to infer the fuel pressure.

### FIELD OF THE INVENTION

The present invention relates to a method for operating a fuel-injection system, in particular of an internal combustion engine, in which fuel stored inside a pressure reservoir is injected by at least one fuel injector. Furthermore, the present invention relates to a computer program for executing such a method, as well as to a control device for a fuel-injection system.

### BACKGROUND INFORMATION

Methods are known and have the disadvantage that inaccuracies in the detection of the fuel pressure inside the pressure reservoir lead to errors in the setting of a setpoint pressure for the fuel pressure, which in turn cause a reduction in the durability of the components of the fuel-injection system and errors in the mixture formation.

### SUMMARY OF THE INVENTION

Accordingly, it is an object of the present invention to improve a method of the type mentioned in the introduction to the effect that greater operational reliability is achieved and the described disadvantages are avoided.

According to the present invention, this object is achieved in that at least one performance quantity of the fuel injector, which is a function of the fuel pressure prevailing inside the pressure reservoir, is evaluated in order to infer the fuel pressure.

According to the present invention it is recognized that with conventional fuel injectors, one or also several performance quantities such as switching times, other variables affecting the dynamic response, and the like are a function of a fuel pressure in the region of the fuel injector and therefore also contain information about a fuel pressure prevailing inside the pressure reservoir.

A corresponding evaluation of the performance quantities that are a function of the fuel pressure thus allows advantageous conclusions with regard to the fuel pressure actually prevailing inside the pressure reservoir.

Increased performance reliability of the fuel-injection system according to the present invention is advantageously provided if a fuel pressure determined with the aid of a pressure sensor is plausibilized by the fuel pressure obtained according to the present invention as a function of at least one performance quantity of a fuel injector.

In a negative plausibility check, a fault of the pressure sensor may advantageously be inferred and/or a fault response initiated.

If a plurality of fuel injectors is provided in the fuel-injection system, then it is advantageously possible that at least one performance quantity that is a function of the fuel pressure prevailing in the pressure reservoir is analyzed for a plurality of fuel injectors, additional possibilities being provided for the mutual plausibilization of the pressure values determined therefrom.

In an especially advantageous manner, it is possible to infer a manipulation of a component of the fuel-injection system, in particular a manipulation of the pressure sensor, on the basis of a comparable deviation between the performance quantities of a plurality of different fuel injectors and specifiable reference data.

According to the present invention, if the fuel injector is designed as a solenoid valve, a switching time of the solenoid valve may advantageously be evaluated as a performance quantity that is a function of the fuel pressure prevailing inside the pressure reservoir.

A control variable of the fuel injector, or of an actuator provided therein, is advantageously evaluated in order to obtain the performance quantity. In a fuel injector designed as a solenoid valve, a control voltage or a control current may be evaluated accordingly in order to determine the performance quantity, whereas in a fuel injector equipped with a piezoelectric actuator, the control voltage of the actuator is preferably evaluated in order to obtain the performance quantity.

The realization of the method according to the present invention in the form of a computer program, which is programmed to execute the method and provided on an electronic storage medium, is of importance.

### BRIEF DESCRIPTION OF THE DRAWINGS

FIG. 1 shows a block diagram of one specific embodiment of the fuel-injection system according to the present invention.

FIG. 2 shows a simplified flow chart of one specific embodiment of the operating method according to the present invention.

FIG. 3 shows a performance quantity of fuel injectors in an internal combustion engine obtained according to the present invention.

### DETAILED DESCRIPTION

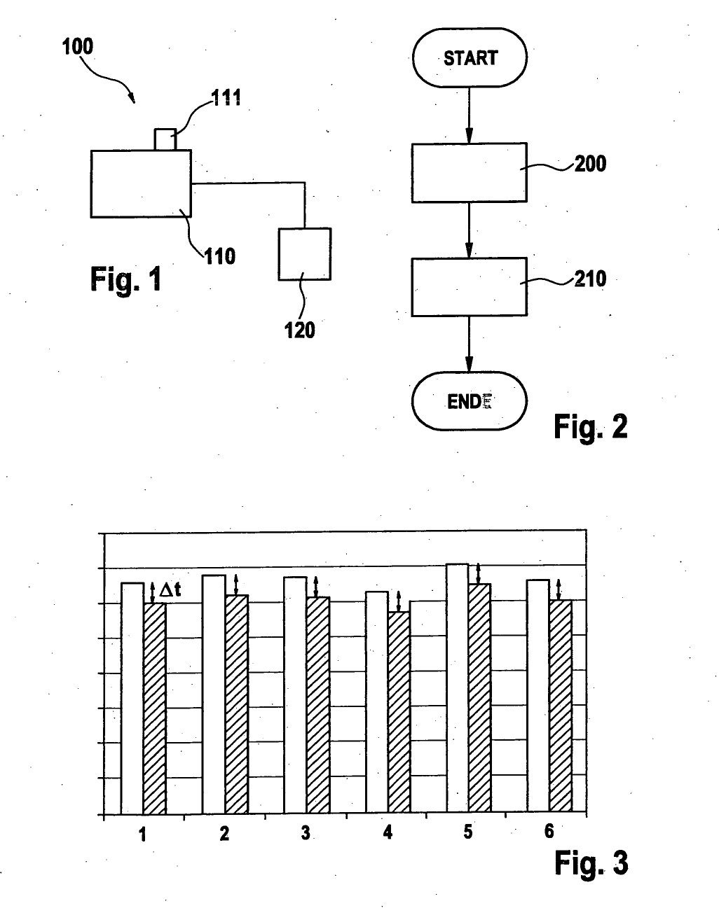

FIG. 1 shows a schematic block diagram of a fuel-injection system 100 according to the present invention, which includes a pressure reservoir 110 for the storing of pressurized fuel. Fuel-injection system 100 includes at least one fuel injector 120, which is connected to pressure reservoir 110, via which the fuel supplied by pressure reservoir 110 is able to be injected into a not depicted combustion chamber of an internal combustion engine, for example.

A pressure sensor 111, which detects the fuel pressure prevailing inside pressure reservoir 110, is assigned to pressure reservoir 110.

To obtain information about the fuel pressure inside pressure reservoir 110 even when a malfunction of pressure sensor 111 has occurred, the method according to the present invention described in the following text with reference to FIG. 2 is implemented.

In a first step 200 of the method according to the present invention, at least one performance quantity of fuel injector 120 which is a function of the fuel pressure prevailing inside pressure reservoir 110 (FIG. 1) is evaluated, which advantageously makes it possible to infer the fuel pressure inside pressure reservoir 110. In other words, the evaluation of the pertinent performance quantity of fuel injector 120 according to the present invention makes it possible to determine the fuel pressure inside pressure reservoir 110 independently of pressure sensor 111, and thus independently of its proper functioning.

On the one hand, this advantageously makes it possible to obtain information about a fuel pressure actually prevailing in pressure reservoir 110 when pressure sensor 111 is malfunctioning and, on the other hand, a pressure signal obtained from pressure sensor 111 may advantageously also be plausibilized by the particular pressure signal that is obtained according to the present invention as a function of the performance quantity of fuel injector 120.

According to the present invention, such an evaluation or plausibilization takes place in the following method step 210 (FIG. 2).

In the case of a negative plausibilization of the pressure-signal value obtained directly from pressure sensor 111, on the basis of a pressure-signal value obtained according to the present invention, a fault of pressure sensor 111 may be inferred, for instance, and/or a corresponding fault reaction be initiated.

If fuel-injection system 100 (FIG. 1) is equipped with a plurality of fuel injectors 120, then the principle of the present invention also makes it possible to analyze at least one performance quantity that is a function of the fuel pressure prevailing inside pressure reservoir 110 for each of the plurality of fuel injectors 120, thereby enabling a plausibilization of the values for the various fuel injectors 120 obtained in this manner.

If each of the performance quantities evaluated for the plurality of fuel injectors 120 according to the present invention indicates a comparable deviation from specifiable reference data and if, furthermore, the pressure values derived from the performance quantities also deviate from the pressure signal of pressure sensor 111, then it is advantageously possible to infer a manipulation of a component of fuel-injection system 100, in particular a manipulation of pressure sensor 111 itself.

Performance quantities of new fuel injectors recorded with the aid of measuring technology, for example, which have been determined on the basis of a known fuel pressure, may be used as reference data.

If fuel injector 120 is embodied in the form of a solenoid valve, it is advantageously possible, for instance, to evaluate a switching time of the solenoid valve as performance quantity that is a function of the fuel pressure prevailing inside pressure reservoir 110. For example, the switching time may indicate how much time is required for the switchover of the solenoid valve from a first operating position to a second operating position at a given fuel pressure.

In this context, FIG. 3 shows the switching times determined for six fuel injectors of fuel-injection system 100, a left value assigned to the particular fuel injector 1, . . . , 6, indicating the switching time prior to a manipulation of pressure sensor 111, and a right value assigned to the particular fuel injector 1, . . . , 6, representing the switching time following a manipulation. The diagram of FIG. 3 clearly illustrates the similar change by time duration Δt in the switching times of all six injection valves 1, . . . , 6 of fuel-injection system 100 from which a manipulation of pressure sensor 111 may be inferred with a high degree of certainty according to the present invention.

For example, a corresponding manipulation of pressure sensor 111 may be brought about by a falsification of the pressure signal that it forwarded to an engine controller, in such a way that a lower fuel pressure than actually present inside pressure reservoir 110 is indicated at all times. In this case the engine controller will attempt to readjust the pressure to a corresponding setpoint value, e.g., by appropriate control of a high-pressure pump supplying pressure reservoir 110. Because of the manipulation of pressure sensor 111, an excessively high fuel pressure comes about as a result, which causes the switching times, shortened by time duration Δt, of the solenoid valves. On this basis the afore-described manipulation is detected with the aid of the method according to the present invention.

In addition to a switching time, other suitable performance quantities of fuel injector 120 may likewise be utilized for the evaluation according to the present invention.

In particular in the case of injection valves that are equipped with piezoelectric actuators, their control variables, e.g., a control voltage or also a control current, may be utilized for the evaluation according to the present invention, provided they are a function of the fuel pressure prevailing inside pressure reservoir 110.

For one, the use of the method according to the present invention thus makes it possible to detect proper functioning of pressure sensor 111 or to plausibilize the function of pressure sensor 111 and, for another, in the case of a defective pressure sensor 111, it is alternatively possible to directly determine at least the fuel pressure prevailing inside pressure reservoir 110 from the performance quantities of fuel injectors 120.

With the aid of the method according to the present invention, it can therefore be ensured that an internal combustion engine equipped with fuel-injection system 100 according to the present invention, or a control device assigned thereto, always obtains correct information about the fuel pressure prevailing inside pressure reservoir 110, which has a positive effect on the service life of the utilized components and on the quality of the mixture formation, as well.

Even intentionally induced manipulations, such as, for instance, the installation of what is known as a tuning kit for enhancing the performance of the internal combustion engine are able to be detected by the method according to the present invention. In contrast to wear-related changes in the fuel-pressure-dependent performance quantities, a manipulation of this type causes a direct change in the particular values.

What is claimed is:

1. A method for operating a fuel-injection system of an internal combustion engine, comprising:
injecting fuel stored inside a pressure reservoir by at least one fuel injector; and
evaluating at least one performance quantity of the fuel injector that is a function of a fuel pressure prevailing in the pressure reservoir in order to infer the fuel pressure.

2. The method according to claim 1, further comprising plausibilizing a fuel pressure inside the pressure reservoir determined with the aid of a pressure sensor.

3. The method according to claim 2, further comprising at least one of (a) inferring a fault of the pressure sensor, and (b) initiating a fault response in the event of a negative plausibilization.

4. The method according to claim 1, further comprising evaluating at least one performance quantity that is a function of the fuel pressure prevailing in the pressure reservoir for a plurality of fuel injectors in each case.

5. The method according to claim 4, further comprising inferring a manipulation of a pressure sensor from a comparable deviation of performance quantities of a plurality of fuel injectors from specifiable reference data.

6. The method according to claim 1, wherein the fuel injector includes a solenoid valve, and further comprising evaluating a switching time of the solenoid valve as a performance quantity that is a function of the fuel pressure prevailing inside the pressure reservoir.

7. The method according to claim 1, further comprising evaluating a control variable of the fuel injector, or of an actuator situated therein, in order to obtain the performance quantity.

8. A computer-readable medium containing a computer program which when executed by a processor performs the following method for operating a fuel-injection system of an internal combustion engine:
injecting fuel stored inside a pressure reservoir by at least one fuel injector; and
evaluating at least one performance quantity of the fuel injector that is a function of a fuel pressure prevailing in the pressure reservoir in order to infer the fuel pressure.

9. A control device for operating a fuel-injection system of an internal combustion engine, comprising at least one arrangement for performing the following:
injecting fuel stored inside a pressure reservoir by at least one fuel injector; and
evaluating at least one performance quantity of the fuel injector that is a function of a fuel pressure prevailing in the pressure reservoir in order to infer the fuel pressure.
